(19) United States
(12) Patent Application Publication
(10) Pub. No.: US 2015/0085325 A1
(43) Pub. Date: Mar. 26, 2015

(54) IMAGE PROCESSING APPARATUS AND IMAGE PROCESSING METHOD

(71) Applicant: KYOCERA DOCUMENT SOLUTIONS INC., Osaka-shi (JP)

(72) Inventor: Masaoki Sato, Osaka-shi (JP)

(21) Appl. No.: 14/388,142

(22) PCT Filed: Feb. 13, 2013
(86) PCT No.: PCT/JP2013/053410

§ 371 Date: Sep. 25, 2014

(30) Foreign Application Priority Data
Mar. 28, 2012 (JP) 2012-073103

(51) Int. Cl. H04N 1/00; H04N 1/21

(52) U.S. Cl. CPC H04N 1/00875; H04N 1/00411; H04N 1/00474; H04N 1/21; H04N 1/00384; H04N 1/00392; H04N 2201/0087; H04N 2201/0093; H04N 2201/0094; H04N 2201/218
USPC 358/444

(57) ABSTRACT

The present invention includes a displaying and accepting unit 401, a storing and deleting unit 404, and an image processing unit 406. The displaying and accepting unit 401 selectably displays a post-processing delete key 607 for deletion after a process as well as image data 605 in an external storage device 128 on a touch screen 201. The storing and deleting unit 404 stores, when the post-processing delete key 607 and predetermined image data 605a are selected, image data 605a in the external storage device 128 corresponding to the image data 605a thus selected to the internal storage unit 405 and deletes the image data 605a from the external storage device 128. The image processing unit 406 executes the process based on the image data 605a stored in the internal storage unit 405.

### TECHNICAL FIELD

The present invention relates to an image processing apparatus and an image processing method, and more specifically to an image processing apparatus and an image processing method that can reduce user's key operations and prevent failure of deletion of image data in an external storage device.

### BACKGROUND ART

Some facsimile devices have a confidential facsimile function. By using such a function, image data that is received is not immediately printed but temporarily stored in internal memory of the facsimile device.

Meanwhile, a user who wishes to use the confidential facsimile function registers his/her authentication data such as a PIN code to the device in advance. When the user inputs the authentication data, in a case in which the input data matches the registered data, and there is an image received for the user who made the input, image data stored in internal memory of the device can be printed out. As a result, confidentiality of the received image data can be kept higher than in a case of normal facsimile reception.

However, in the conventional facsimile device with the above described confidential facsimile function, an original document is used for submission of the image data, and the received image data is discharged as a printed matter. The original document and the printed matter may be seen by a third party, and further confidentiality in this regard has been desired.

Given this, Japanese Unexamined Patent Application Publication No. 2006-325028 (Patent Document 1) discloses a facsimile device provided with: a connecting means that connects an external storage device; a detecting means that detects whether the external storage device is connected to the connecting means; and a switching means that makes the confidential facsimile submitting function available in a case in which the external storage device is connected to the connecting means, and makes the confidential facsimile submitting function unavailable in a case in which the external storage device is not connected to the connecting means. The facsimile device is provided also with: a display means that displays file names of image data that can be faxed among the image data stored in the external storage device connected to the connecting means; a file selecting means that selects a file to be submitted from the files displayed on the display means based on the user's instruction; and a submitting means that submits the image data of the file selected by the file selecting means by a confidential facsimile submitting function. As a result, the confidential facsimile submitting function is made available only when the external storage device is connected to the connecting means, and the image data of the file specified by the user among the files stored in the external storage device is automatically submitted by the confidential facsimile function. As a result, by storing the image data to be submitted in the external storage device, an original document is no longer necessary upon confidential facsimile submission. This is claimed to eliminate the risk that the image data to be submitted is seen by the third party, and to secure higher confidentiality.
Patent Document 1: Japanese Unexamined Patent Application Publication No. 2006-325028

### DISCLOSURE OF THE INVENTION

### Problems to be Solved by the Invention

In handling of the image data in the external storage device as described above, a determination of whether the image data is to be kept in the external storage device or to be deleted from the external storage device is often made after instructing to execute a process on the image data in a device (for example, a facsimile apparatus and an image processing apparatus) connected to the external storage device. This leads to a problem of a user failing to make the instruction after instructing to execute the process on the image data in the external storage device. Such a failure of deletion of the image data is not a problem if the image data is to be kept stored after printing. On the contrary, in a case in which it is necessary to delete the image data after printing, failing to do so will result in the image data accumulating in the external storage device unnecessarily, and undesirably consume memory space of the external storage device. In the invention disclosed in Patent Document 1, since an inquiry of whether the data is to be deleted or not is made to the user after completion of the process of the image data in the external storage device, the above described problem cannot be overcome.

### Means for Solving the Problems

An image processing apparatus of the present invention supposes an image processing apparatus that executes a process based on image data in an external storage device mounted to an image forming apparatus, and employs the following configurations.

More specifically, the image processing apparatus includes a displaying and accepting unit, a storing and deleting unit, and an image processing unit. The displaying and accepting unit selectably displays a post-processing delete key for deletion after the process as well as the image data in the external storage device on a touch screen. The storing and deleting unit stores, when the post-processing delete key and predetermined image data are selected, image data in the external storage device corresponding to the image data thus selected to an internal storage unit and deletes the image data from the external storage device. The image processing unit executes the process based on the image data stored in the internal storage unit.

The present invention can be provided as an image processing method of an image processing apparatus that executes a process based on image data in an external storage device mounted to an image forming apparatus.

More specifically, the image processing method includes a displaying step, a deleting step, and an executing step. The displaying step selectably displays a post-processing delete key for deletion after the process as well as the image data in the external storage device on a touch screen. The deleting step stores, when the post-processing delete key and predetermined image data are selected, image data in the external storage device corresponding to the image data thus selected to an internal storage unit and deletes the image data from the external storage device. The executing step executes the process based on the image data stored in the internal storage unit.

### BRIEF DESCRIPTION OF THE DRAWINGS

FIG. 1 is a schematic view illustrating an overall internal configuration of a multi-function peripheral according to an embodiment of the present invention;

FIG. 2 is a schematic view illustrating the overall configuration of an operation unit according to the embodiment of the present invention;

FIG. 3 is a diagram showing a configuration of controlling hardware of the multi-function peripheral according to the embodiment of the present invention;

FIG. 4 is a functional block diagram of the multi-function peripheral according to the embodiment of the present invention;

FIG. 5 is a flowchart showing an execution procedure of the embodiment of the present invention;

FIG. 6A is a diagram illustrating an example of a print window displayed on a touch screen according to the embodiment of the present invention;

FIG. 6B is a diagram illustrating an example of an external storage device print window displayed on the touch screen according to the embodiment of the present invention;

FIG. 7A is a diagram illustrating an example of a state in which a drag-and-drop operation has been made in the external storage device print window displayed on the touch screen according to the embodiment of the present invention;

FIG. 7B is a diagram illustrating an example of an external storage device setting window displayed on the touch screen according to the embodiment of the present invention;

FIG. 8A is a diagram illustrating an example of the external storage device print window displayed on the touch screen according to the embodiment of the present invention; and

FIG. 8B is a diagram illustrating an example of a state in which the drag-and-drop operation has been made in the external storage device print window displayed on the touch screen according to the embodiment of the present invention.

### EXPLANATION OF REFERENCE NUMERALS

100 Multi functional peripheral
102 Operation unit
128 Internal storage device
401 Displaying and accepting unit
402 Mounting detecting unit
403 External storage unit
404 Storing and deleting unit
405 Internal storage unit
406 Image processing unit

### PREFERRED MODE FOR CARRYING OUT THE INVENTION

An embodiment of the image processing apparatus according to the present invention is described hereinafter with reference to the attached drawings. It should be noted that the embodiment below is an example of an implementation of the present invention and is not intended to limit the technical scope of the present invention. Moreover, the prefixed alphabetical letter “S” attached to numbers in flow charts represents “step”.

### Image Processing Apparatus

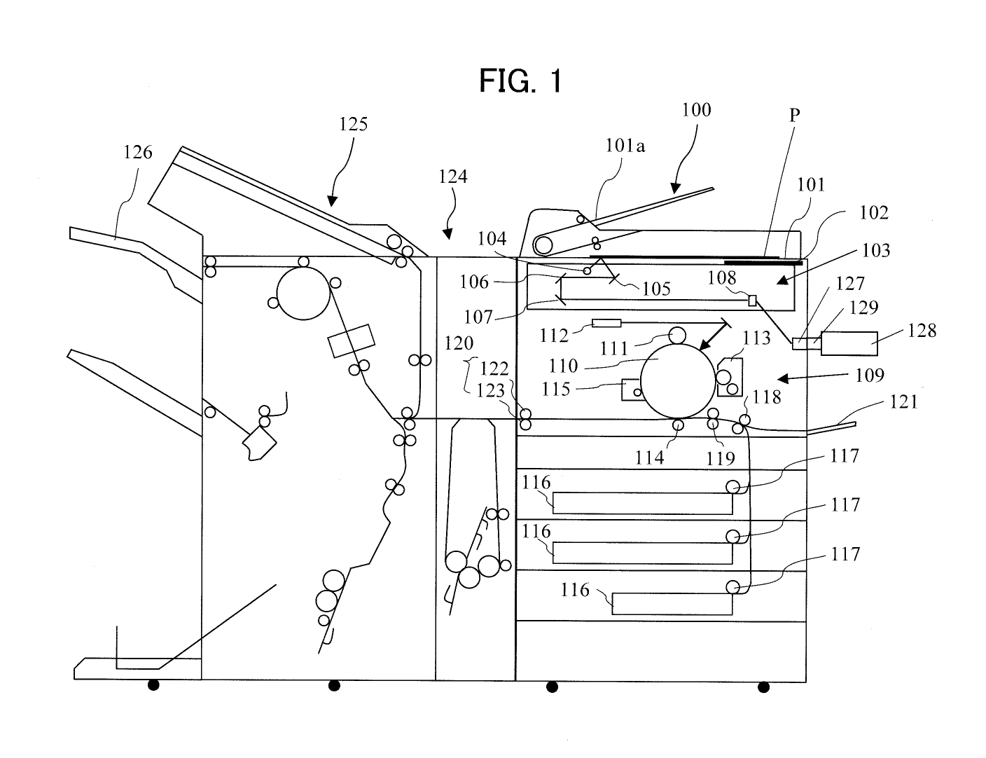

Hereafter, an image processing apparatus provided with a post-processing device according to an embodiment of the present invention will be described. FIG. 1 is a schematic view of an image processing apparatus according to an embodiment of the present invention. It should be noted that the details of parts that are not directly related to the present invention are omitted.

The image processing apparatus according to the present invention is, for example, a stand-alone printer and a scanner, or a multi-function peripheral that includes a printer, a copier, a scanner, a FAX, or the like, which functions as an image processing apparatus including a copy function, a scanner function, a facsimile function, a printer function and the like.

Operation of a multi-function peripheral 100 (MFP: Multi function Peripheral) in the case in which copy function is used, for example, will be described briefly below.

First, a user turns on the multi-function peripheral 100, places an original P on a platen 101 or an automatic original feeding unit 101a provided at a top face of the multi-function peripheral 100, and inputs settings of the copy function from an operation unit 102. On the operation unit 102, a print window (initial window and the like) relating to the copy function provided by the multi-function peripheral 100 is displayed, and a plurality of setting item keys relating to the copy function is pushably displayed. A user inputs a setting condition relating to the copy function from the print window. After completing the input of the setting condition, the user makes the multi-function peripheral 100 start the process of the copy function by pressing a start key provided in the operation unit 102.

When the multi-function peripheral 100 starts processing the copy function, in an image reading unit 103, a light emitted from a light source 104 is reflected by the original P placed on the platen 101. Alternatively, in a case in which the original P has been placed on the automatic original feeding unit 101a, the automatic original feeding unit 101a conveys the original P sheet by sheet toward an image reading position in the image reading unit 103. The light source 104 emits light toward the image reading position, and the light is reflected by the original P.

The light thus reflected is guided to an imaging device 108 by mirrors 105, 106, and 107. The light thus guided is photoelectrically converted by the imaging device 108, and subjected to basic correction process, image quality process, compression process and the like. Image data corresponding to the original P is thus generated.

It should be noted that the image data is not limited to the image data being read by the image reading unit 103. The image data may also be, for example, image data in an external storage device 128 obtained by mounting the mounting portion 129 of the external storage device 128 to a mounting target portion 127 provided on a side face of the multi-function peripheral 100 for the external storage device.

The image forming unit 109 is a driving unit that transfers the image data as a toner image to a storage medium. The above image forming unit 109 is provided with a photoreceptor drum 110. The photoreceptor drum 110 rotates in a predetermined direction at a constant speed. In the periphery of the photoreceptor drum 110, a charging device 111, an exposure unit 112, a developing device 113, a transfer device 114, a cleaning unit 115 and the like are disposed, in this order from an upstream side in a rotational direction.

The charging device 111 uniformly charges a surface of the photoreceptor drum 110. The exposure unit 112 irradiates a surface of the photoreceptor drum 110 thus charged with laser based on the image data, thereby forming an electrostatic latent image. The developing device 113 deposits toner on the electrostatic latent image being conveyed, thereby forming a toner image. The toner image thus formed is transferred to a storage medium (for example, a sheet and paper) by the transfer device 114. The cleaning unit 115 removes excessive toner remaining on the surface of the photoreceptor drum 110. This series of processes is performed by rotation of the photoreceptor drum 110.

The paper is fed from a plurality of paper feeding cassettes 116 provided in the multi-function peripheral 100. Upon conveyance, the paper is pulled out from any one of the paper feeding cassettes 116 to a conveyance path by a pickup roller 117. In each of the paper feeding cassettes 116, paper of different types are stored. The paper is fed according to a setting relating to the output condition.

The paper thus pulled out to the conveyance path is fed into between the photoreceptor drum 110 and the transfer device 114 by a conveyance roller 118 and a registration roller 119. Once the paper is thus fed, the toner image is transferred to the paper by the transfer device 114. Thereafter, the paper is conveyed to the fusing device 120. The paper conveyed by the conveyance roller 118 may also be conveyed from a manual feeding tray 121 provided in the multi-function peripheral 100.

As the paper to which the toner image has been transferred passes between a heating roller 122 and a pressurizing roller 123 provided in the fusing device 120, heat and pressure are applied to the toner image to thereby fuse the toner image onto the paper. Heat quantity of the heating roller 122 is optimized according to a type of the paper, in order to realize the fusing appropriately. The image formation is completed with fusing of the toner image onto the paper. The paper onto which the toner image has been fused is conveyed to the folding device 124 via the fusing device 120.

The paper thus conveyed is subjected to a folding process in the folding device 124, according to the setting conditions input by the user. In a case in which the setting conditions for the folding process have not been input, the paper simply passes through the folding device 124.

In addition, in a case in which post-processing (for example, stapling, punching, binding and the like) has been input as the setting condition by the user, the paper having passed through the folding device 124 is fed to the binding device 125 for post-processing. In the post-processing, in a case of binding process, the binding device 125 performs a punching process on each of the plurality of sheets of paper by means of a punching processing unit (not illustrated), and performs a stapling process on all of the paper by means of a stapling processing unit (not illustrated).

The paper or a stack of paper having undergone the post-processing is subsequently placed on and stored in the discharged paper tray 126 of the binding device 125. The folding device 124 and the binding device 125 are collectively referred to as the post-processing device (finisher). By the above described steps, the multi-function peripheral 100 provides the copy function to a user.

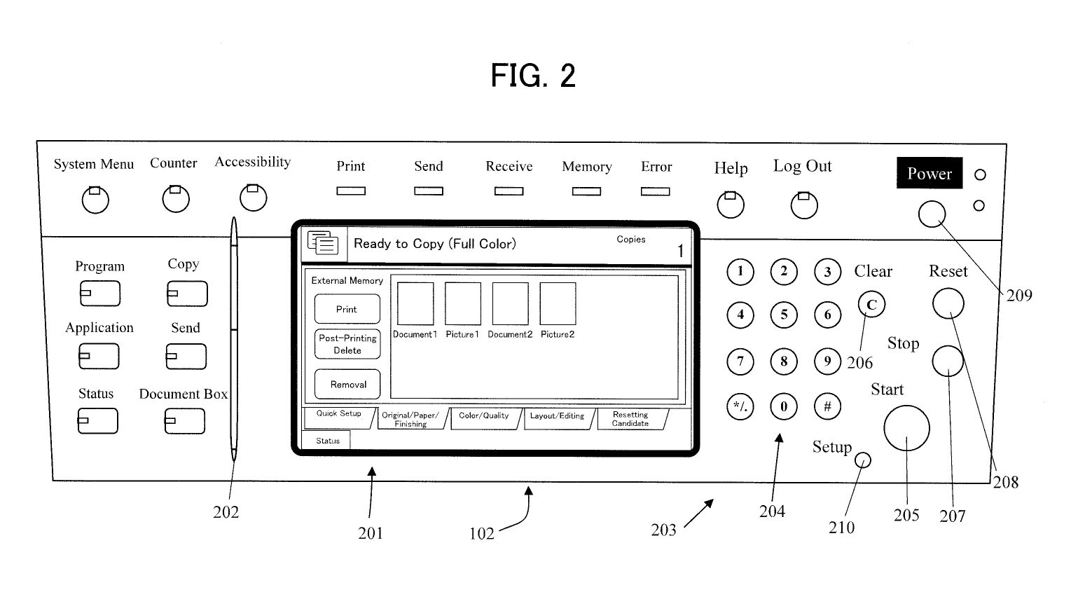

FIG. 2 is a conceptual diagram showing an overall configuration of the operation unit according to the embodiment of the present invention. A user inputs the setting conditions or the like and confirms the setting conditions being input in relation to image formation as described above by use of the operation unit 102. When the setting conditions are to be input, the touch screen 201 (operation panel) provided in the operation unit 102, a stylus pen 202, and the operation key 203 are used.

The touch screen 201 is provided with both a function of inputting the setting conditions and a function of displaying the setting conditions. In other words, by pressing a key in a window displayed on the touch screen 201, a setting condition corresponding to the pressed key is input.

A display unit (not illustrated) such as an LCD (Liquid Crystal Display) or the like is provided on a back face of the touch screen 201. The display unit displays, for example, an operation window such as the initial window and the like. In the vicinity of the touch screen 201, the stylus pen 202 is provided. As the user brings a tip end of the stylus pen 202 into contact with the touch screen 201, a sensor provided under the touch screen 201 detects a contacted point.

Furthermore, in the vicinity of the touch screen 201, a predetermined number of operation keys 203 (for example, numeric keys 204, a start key 205, a clear key 206, a stop key 207, a reset key 208, and a power key 209) is provided.

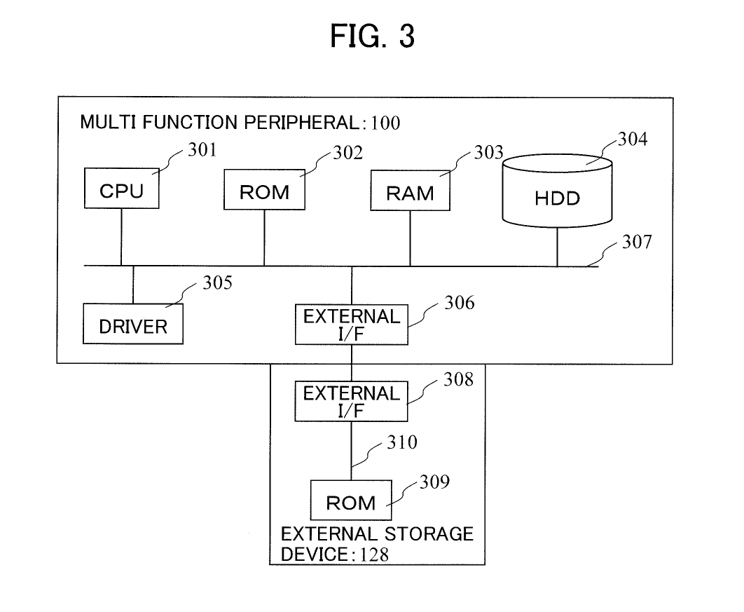

Next, a configuration of controlling hardware of the multi-function peripheral 100 is described with reference to FIG. 3. FIG. 3 is a diagram illustrating a configuration of controlling hardware of the multi-function peripheral 100 according to the present invention. It should be noted that the details of parts that are not directly related to the present invention are omitted.

A control circuit of the multi-function peripheral 100 is configured such that a CPU (Central Processing Unit) 301, ROM (Read Only Memory) 302, RAM (Random Access Memory) 303, a HDD (Hard Disk Drive) 304, drivers 305 corresponding to respective driving units, and an external interface (I/F) 306 are connected via an internal bus 307.

The CPU 301 uses the RAM 303 as workspace, for example, and executes programs stored in the ROM 302, the HDD 304 and the like. The CPU 301 receives data, instructions and the like from the drivers 305 and the operation unit 102 based on a result of the execution, and controls operation of the driving units shown in FIGS. 1 and 2.

To the external I/F 306 of the multi-function peripheral 100, an external interface (I/F) 308 of the external storage device 128 is connected. The CPU 301 communicates with memory such as the ROM 309 installed in the external storage device 128 via the external I/Fs 306, 308 to thereby acquire and delete data. The ROM 309 is connected to the external I/F 308 via the internal bus 310. It should be noted that the ROM 309 can be any means which stores data, for example a HDD.

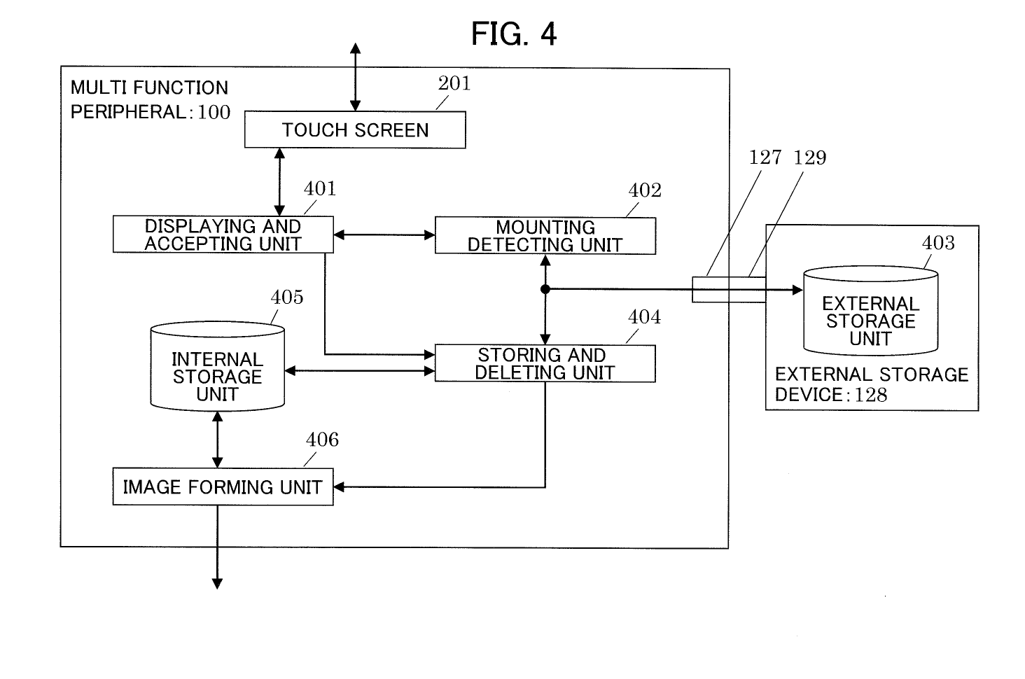

Units (illustrated in FIG. 4) described hereafter other than the driving units are also realized by execution of programs by the CPU 301. The programs or data for realization of each unit described below are stored in the ROM 302.

### Embodiment of the Present Invention

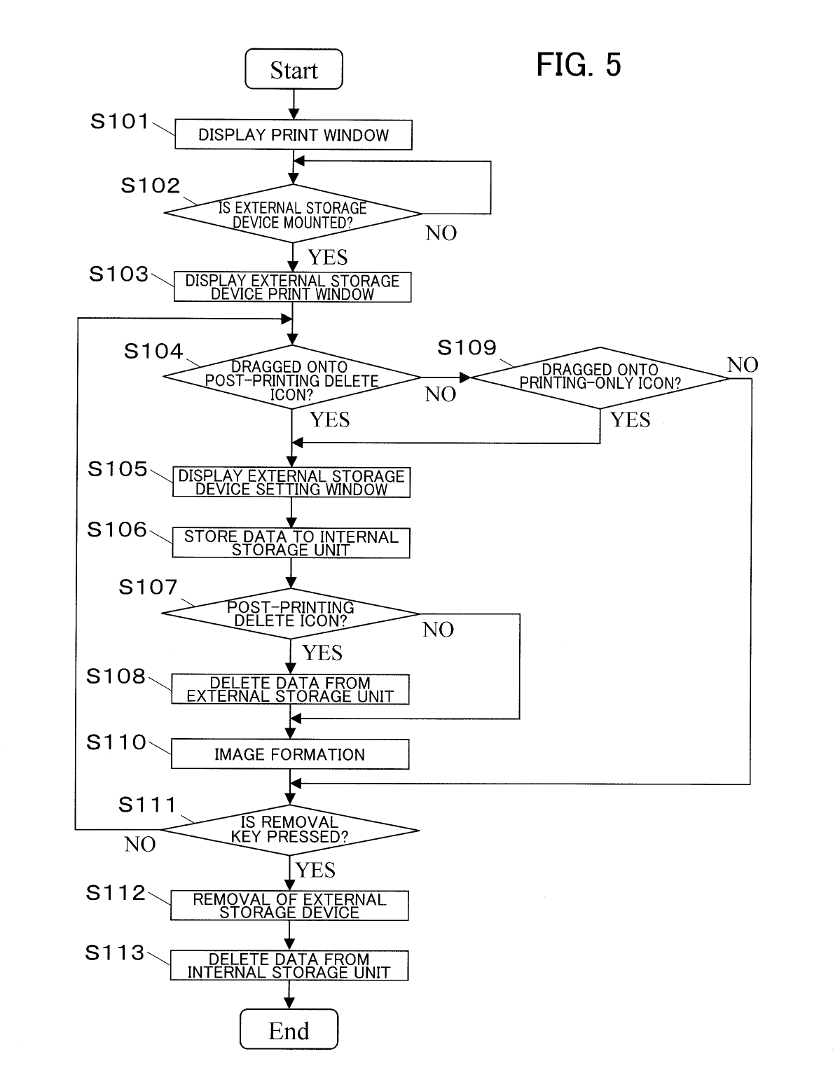

Next, a configuration and execution procedure according to the embodiment of the present invention will be described with reference to FIGS. 4 and 5. FIG. 4 is a functional block diagram of the multi-function peripheral of the present invention. FIG. 5 is a flowchart showing the execution procedure of the present invention.

First, when the user powers on the multi-function peripheral 100, the displaying and accepting unit 401 of the multi-function peripheral 100 displays a preset print window (initial window) on the touch screen 201 of the operation unit 102 (FIG. 5: S101).

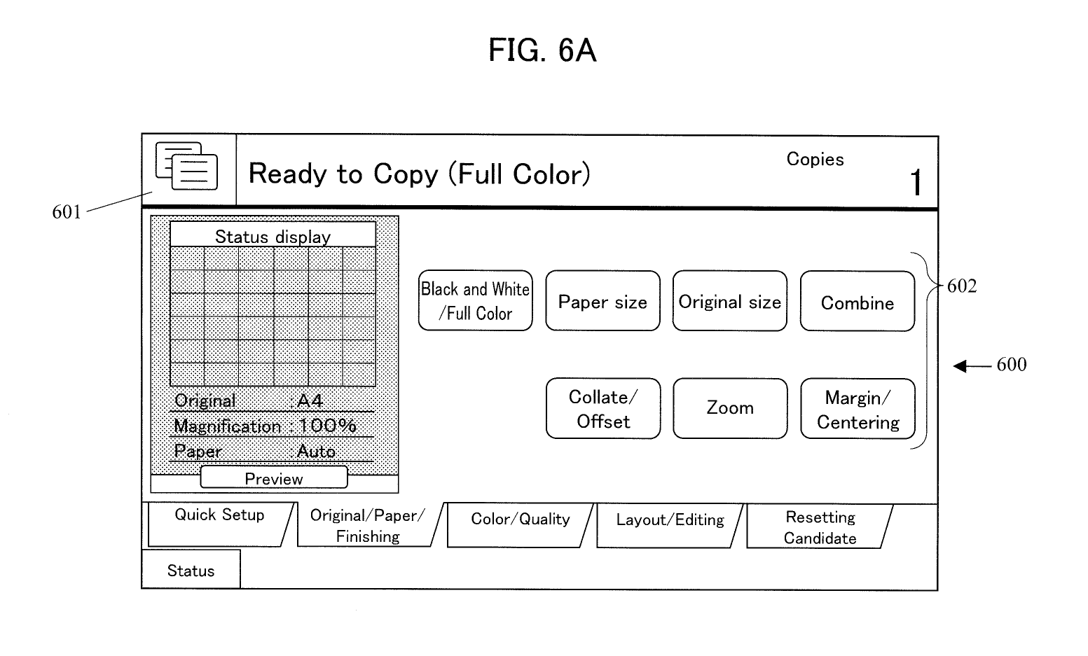

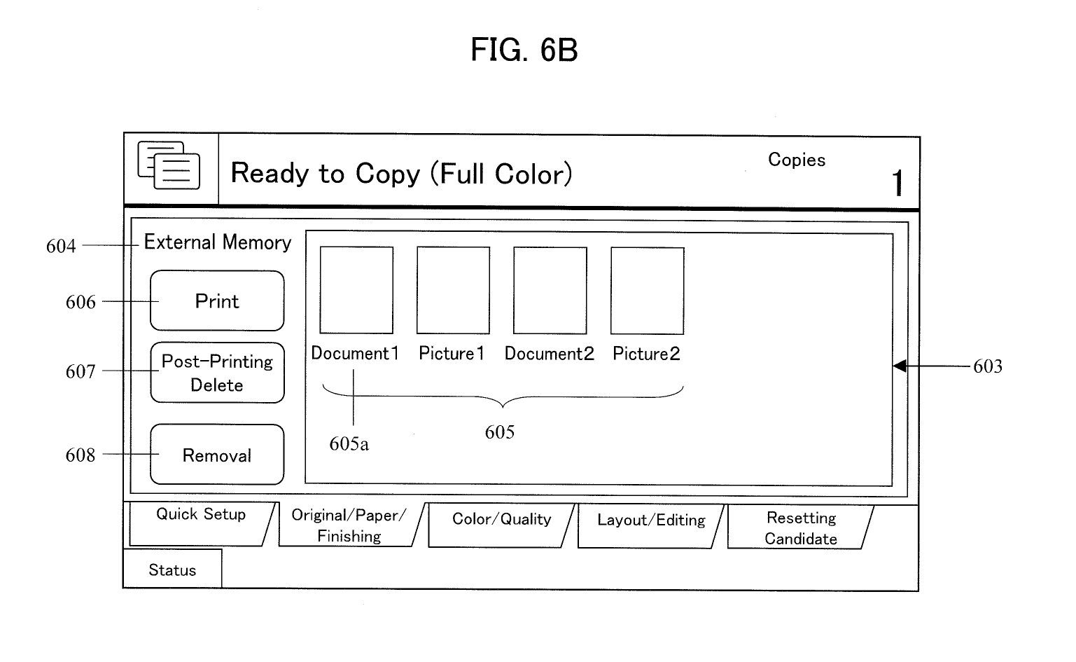

In the print window 600, a message 601 for prompting printing setting and the like, and setting items 602 (for example, “Black and White/Full Color”, “Zooming” and the like) for inputting setting conditions for printing are displayed as shown in FIG. 6A.

Here, as the user mounts the mounting portion 129 of the predetermined external storage device 128 (for example, USB memory, an SD memory card, a compact flash card, a memory stick, and the like) to the mounting target portion 127 (attachment opening) of the multi-function peripheral 100, a mounting detecting unit 402 detects mounting of the external storage device 128 (FIG. 5: S102; YES) and notifies the displaying and accepting unit 401 of the mounting. Upon accepting the notification, the displaying and accepting unit 401 refers to the external storage unit 403 of the external storage device 128 to thereby acquire image data stored in the external storage unit 403, while popping up an external storage device print window based on the image data on a front face of the print window 600 (FIG. 5: S103).

The external storage device print window 603 displays, as shown in FIG. 6B: a message 604 indicating that the image data in the external storage device 128 is to be displayed; image data 605 from the external storage device 128 (reduced data, thumbnail data); a printing-only icon 606 (printing-only key) indicating that only printing is to be executed; a post-printing delete icon 607 (post-printing delete key) indicating that deletion is to be executed after printing; and a removal key 608 for removing the external storage device 128.

The displaying and accepting unit 401 is not particularly limited as long as the image data 605, the printing-only icon 606, and the post-printing delete icon 607 are selectably displayed on the touch screen 201. For example, the displaying and accepting unit 401 displays the image data 605 in the external storage device 128 on the external storage device print window 603 to be draggable and droppable, and when the predetermined image data 605 is dragged and dropped onto the printing-only icon 606 or and the post-printing delete icon 607, makes the predetermined image data 605, as well as the printing-only icon 606 or and the post-printing delete icon selectable.

This allows a user to review (browse) the image data 605 in the external storage device 128, and to drag and drop the image data 605 to give an instruction of image formation (printing) with a reduced number of key operations.

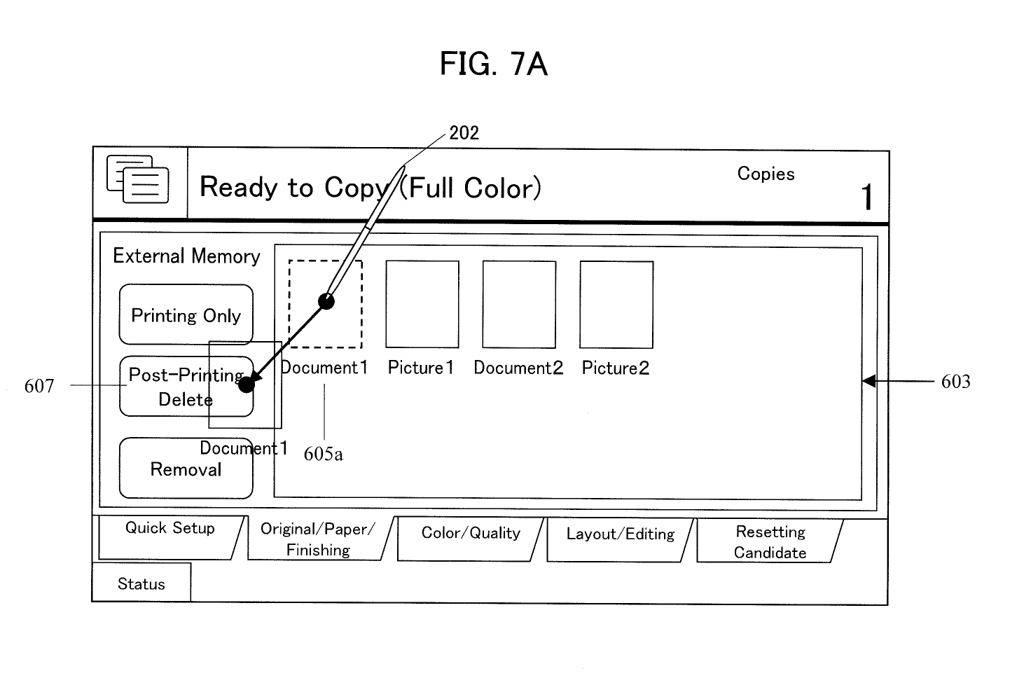

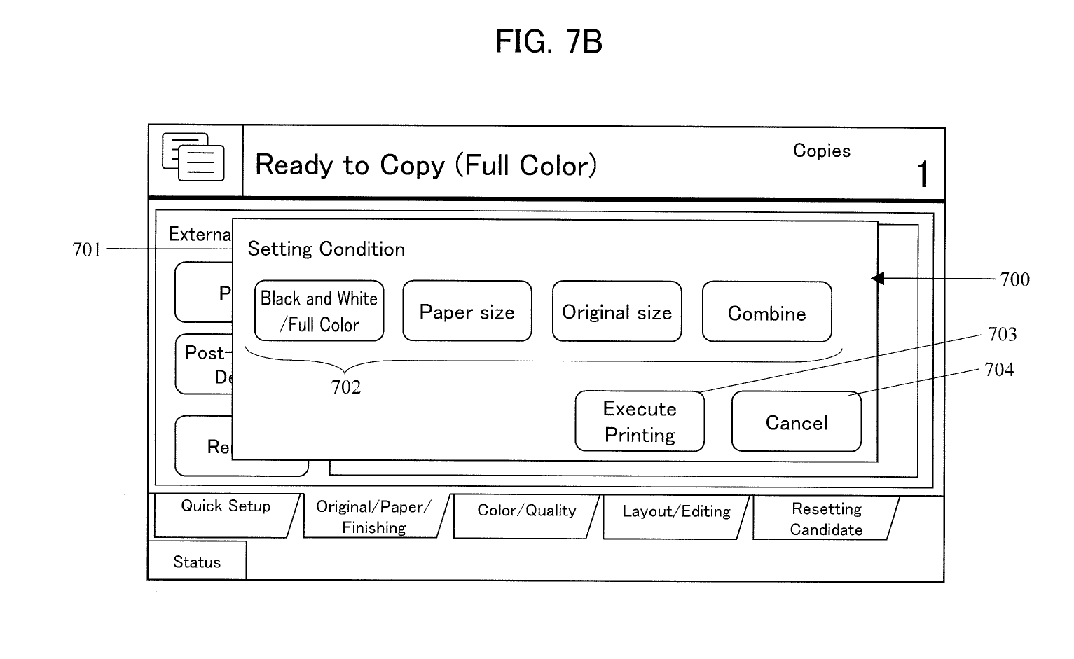

When the user drags and drops the predetermined image data 605a (image data of “document 1”) onto the post-printing delete icon 607 using, for example, the stylus pen 202 as shown in FIG. 7A while looking at the external storage device print window 603, the following processing takes place. More specifically, the displaying and accepting unit 401 accepts the drag and drop operation (FIG. 5: S104; YES) and then pops up an external storage device setting window for input of setting conditions for image formation (printing) of the image data 605a on a front face of the external storage device print window 603 (FIG. 5: S105).

In the external storage device setting window 700, as shown in FIG. 7B; a message 701 indicating that setting conditions are shown; a predetermined number of setting items 702 (for example, “Black and White/Full Color”, “Paper Size” and the like); a printing execution key 703 for executing printing; and a cancel key 704, are displayed.

Here, by limiting the number of minimum required setting items for printing (for example, “Black and White/Full Color”, “Paper Size” and the like) compared to the setting items 602 in the print window 600, the setting items 702 of the external storage device setting window 700 can alleviate the burden of user performing key operation. It should be noted that predetermined initial values (for example, “Auto”) are defined in advance for setting values for the setting items (for example, “Paper Size”).

When the user presses a predetermined setting item 702 while looking at the external storage device setting window 700 and inputs the predetermined setting value (for example, “Black and White”) for the setting item 702 (for example, “Black and White/Full Color”), the displaying and accepting unit 401 accepts the setting value thus input as a setting condition. And then, when the user presses the printing execution key 703 in the external storage device setting window 700, the displaying and accepting unit 401 accepts the setting value and the pressing of the printing execution key 703, and notifies a storing and deleting unit 404 of these operations. Upon reception of the notification, the storing and deleting unit 404 first stores the image data 605a in the external storage device 128 corresponding to the dragged image data 605a to an internal storage unit 405 of the multi-function peripheral 100 (FIG. 5: S106).

As a result, the image processing unit 406 of the multi-function peripheral 100 can execute image formation based on the image data 605a in the internal storage unit 405 without referring to the external storage unit 403 of the external storage device 128.

Next, the storing and deleting unit 404 determines whether the icon onto which the image data was dropped is the post-printing delete icon 607 or not (FIG. 5: S107).

Here, as a result of the determination, in a case in which the icon onto which the image data was dropped is the post-printing delete icon 607 (FIG. 5: S107; YES), the storing and deleting unit 404 refers to the external storage unit 403 to search for the image data 605a which was dropped, and deletes the image data 605a thus searched from the external storage unit 403 (FIG. 5: S108).

As a result, the image data 605a in the external storage unit 403 can be deleted in accordance with the user's intention of deleting after printing. In other words, by using the post-printing delete icon 607, the user can give instructions of: the image formation based on the image data 605a selected by the user; and the deletion of the image data 605a from the external storage unit 403, at the same time. An inquiry of whether the image data 605a is to be deleted from the external storage device 128 is thus no longer necessary, and a failure of deletion of the image data 605a from the external storage device 128 can be prevented. In addition, consumption (occupation) of memory space of the external storage device 128 by the unnecessary image data 605a due to the failure of deletion can thus be prevented. Furthermore, by getting rid of the inquiry, key operations, which are cumbersome to the user, can be reduced.

On the other hand, in S104, in a case in which the user drags and drops the predetermined image data 605a onto the printing-only icon 606 while looking at the external storage device print window 603 (FIG. 5: S109; YES) without dragging and dropping the predetermined image data 605a onto the post-printing delete icon 607 (FIG. 5: S104; NO), the following processing takes place. More specifically, the displaying and accepting unit 401 accepts the predetermined setting condition via the external storage device setting window 700 (FIG. 5: S105). The storing and deleting unit 404 stores the image data 605a to the internal storage unit 405 (FIG. 5: S106). However, in S107, in a case in which the icon onto which the image data was dropped is not the post-printing delete icon 607 (FIG. 5: S107; NO), in other words, in a case in which the icon onto which the image data was dropped is the printing-only icon 606, the storing and deleting unit 404 does not delete the image data 605a.

As a result, the image data 605a in the external storage unit 403 can be kept stored therein without being deleted, in accordance with the user's intention of executing only printing.

Upon completion of a process of deleting the image data 605a in the external storage unit 403 (FIG. 5: S108) or a process of not deleting the image data 605a (FIG. 5: S107; NO), the storing and deleting unit 404 notifies the image processing unit 406 of the completion. Upon reception of the notification, the image processing unit 406 executes image formation on predetermined paper based on the image data 605a stored in the internal storage unit 405 and the setting condition accepted via the external storage device setting window 700 (FIG. 5: S110).

As a result, the user can obtain a printed matter corresponding to the image data 605a in the external storage device 128.

Upon completion of the image formation, the image processing unit 406 notifies the displaying and accepting unit 401 of the completion. Upon reception of the notification, the displaying and accepting unit 401 clears the external storage device setting window 700 from the front face of the external storage device print window 603 and displays the external storage device print window 603 with the removal key 608 being displayed (FIG. 5: S111).

As a result, in a case in which the user wishes to further execute image formation of other image data, the user carries out the key operation as described above using the post-printing delete icon 607 or the printing-only icon 606.

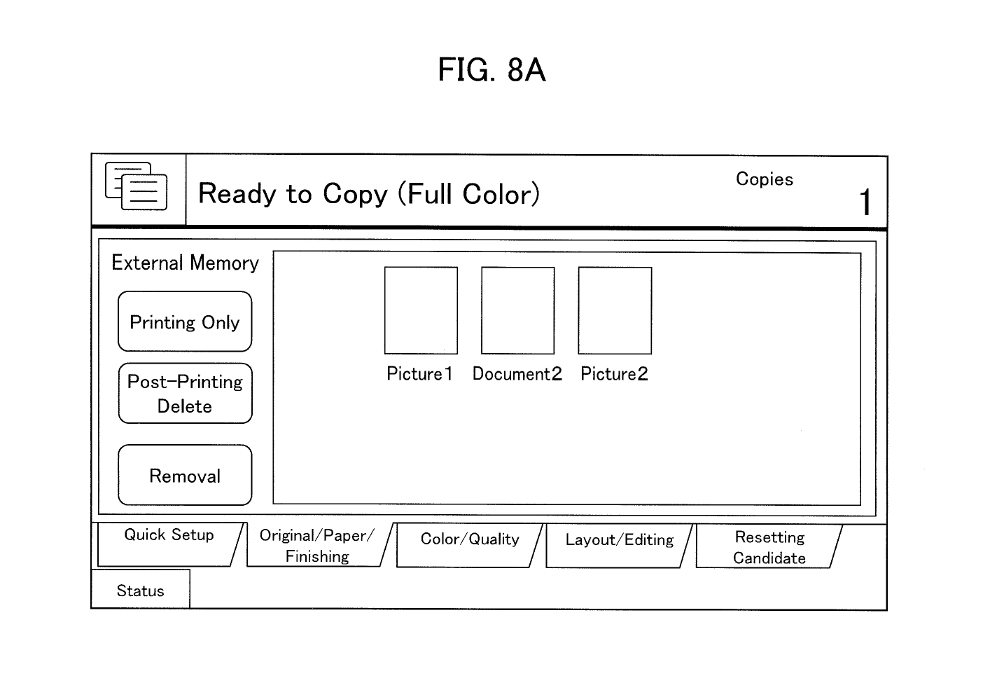

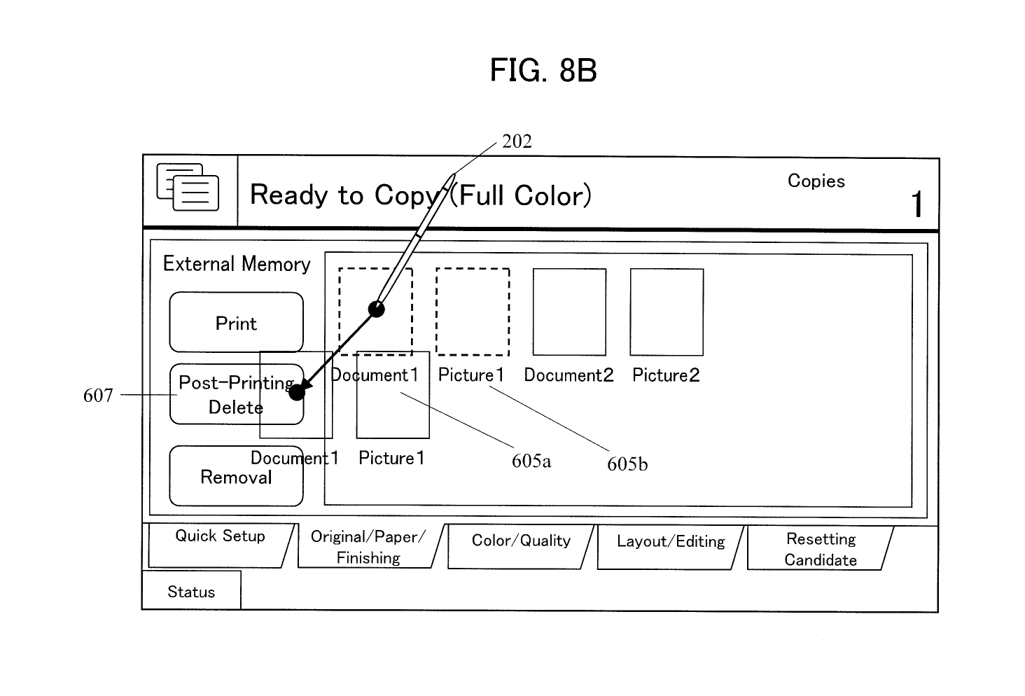

In a case in which the image data 605a, which was a target of image formation and deletion, has been deleted as a result of using the post-printing delete icon 607, the image data 605a among the image date 605, which was a target of image formation and deletion, is cleared from the external storage device print window 603, as shown in FIG. 8A. This allows the user to confirm that the image data 605a has been deleted from the external storage device 128.

On the other hand, in a case in which the image data 605a, which was a target of image formation, has not been deleted as a result of using the printing-only icon 606, the image data 605a is kept displayed on the external storage device print window 603, as shown in FIG. 6A.

In S111, when the user presses the removal key 608 while looking at the external storage device print window 603, the displaying and accepting unit 401 accepts the pressing of the removal key 608 (FIG. 5: S111; YES) and notifies the mounting detecting unit 402 of the pressing. Upon reception of the notification, the mounting detecting unit 402 interrupts a signal from the external storage device 128 and a signal to the external storage device 128, and executes a process allowing safe removal of the external storage device (FIG. 5: S112). As a result, the user can safely remove the external storage device 128.

Next, the displaying and accepting unit 401 notifies the storing and deleting unit 404 of the pressing of the removal key 608. Upon reception of the notification, the storing and deleting unit 404 deletes the image data 605a in the internal storage unit 405 that has been stored by using the post-printing delete icon 607 and/or the printing-only icon 606 (FIG. 5: S113).

The image formation using the image data 605 in the external storage device 128 is thus completed. Upon completion of deletion of the image data 605a in the internal storage unit 405, the storing and deleting unit 404 notifies the displaying and accepting unit 401 of the completion. Upon reception of the notification, the displaying and accepting unit 401 clears the external storage device print window 603 and displays the print window 600 on the touch screen 201. In other words, the initial state is restored.

As described above, the multi-function peripheral 100 of the present invention includes the displaying and accepting unit 401, the storing and deleting unit 404, and the image processing unit 406. The displaying and accepting unit 401 selectably displays the post-processing delete key 607 for deletion after the process as well as the image data 605 in the external storage device 128 on the touch screen 201. The storing and deleting unit 404 stores, when the post-processing delete key 607 and predetermined image data 605a are selected, image data 605a in the external storage device 128 corresponding to the image data 605a thus selected to the internal storage unit 405 and deletes the image data 605a from the external storage device 128. The image processing unit 406 executes the process based on the image data 605a stored in the internal storage unit 405.

As a result, by selecting the image data 605a and the post-printing delete icon 607, the user can give instructions of: the image formation based on the image data 605a; and the deletion from the external storage device 128, at the same time. An inquiry of whether the image data 605a is to be deleted from the external storage device 128 after completion of the image formation is thus no longer necessary, and a failure of deletion of the image data 605a from the external storage device 128 can be prevented. Furthermore, by eliminating the need for the inquiry, key operations, which are cumbersome to the user, can be reduced.

It should be noted that, in the present embodiment, the image formation (printing) has been employed as the process; however, the process can be other process as long as the process is based on the image data in the external storage device. The process can be, for example, a scanning process, a facsimile submitting process, a printing process, a memory box process, a post process, and the like.

In addition, in the embodiment of the present invention, the displaying and accepting unit 401 accepts selection of a piece of image data 605a and the post-printing delete icon 607 (in other words, accepts a drag and drop operation of the piece of image data 605a onto the post-printing delete icon 607). In addition, the storing and deleting unit 404 is configured to execute processes such as deleting and storing with respect to the piece of image data 605a. However, the present invention is not limited thereto and can be alternatively configured, for example, to accept selection of a plurality of pieces of image data and the post-printing delete icon 607.

For example, when the user drags and drops a plurality of pieces of image data (for example, image data of “document 1” 605a and image data of “picture 1”) onto the post-printing delete icon 607 as shown in FIG. 8B, the following processing can also take place. More specifically, when the displaying and accepting unit 401 accepts the drag and drop operation of the plurality of pieces of image data onto the post-processing delete icon 607, the storing and deleting unit 404 can execute processes such as deleting and storing with respect to the plurality of pieces of image data 605a, 605b. In such a configuration, instructions of the image formation and the deletion from the external storage device 128 can be given at the same time, collectively (all at once) to the plurality of pieces of image data 605, and further improvement of efficiency can be made. It should be noted that a method of dragging and dropping the plurality of pieces of image data onto the post-printing delete icon 607 can also be a well-known method. For example, a method in which the user clicks on the piece of image data 605a and then on the piece of image data 605b successively to thereby make these two pieces of image data 605a, 605b draggable, and then drops onto the post-printing delete icon 607 is known.

The above described configuration can be employed for the printing-only icon 606 in place of the post-printing delete icon 607. In addition, the present invention can also be configured such that, when the displaying and accepting unit 401 accepts the drag and drop operation of the plurality of pieces of image data onto the post-processing delete icon 607, the displaying and accepting unit 401 displays only one external storage device setting window 700 for the plurality of pieces of image data in order to collectively accept setting conditions for the plurality of pieces of image data. In addition, the displaying and accepting unit 401 can also be configured to accept respective setting conditions for the plurality of pieces of image data by displaying the external storage device setting window 700 for each of the plurality of pieces of image data.

Furthermore, in the embodiment of the present invention, the present invention is configured such that the multi-function peripheral 100 includes units; however, the present invention is not limited thereto. The present invention can also be configured such that a storage medium, which stores a program realizing the units, is provided. In such a configuration, the multi-function peripheral 100 reads the programs, thereby realizing the respective units by the multi-function peripheral 100. In this case, the program which is read from the storage medium itself provides the advantageous effect of the present invention. Alternatively, steps executed by the various units can be provided as methods stored in a hard disk.

The present invention can also be provided as a program to be executed by a computer, independently distributed through telecommunication lines or the like. In this case, a central processing unit (CPU) realizes a control operation in cooperation with other circuits according to the program of the present invention. The units realized by the program and the CPU can also be configured with specialized hardware. The program can be made available in a state of being recorded on a computer-readable storage medium, such as a CD-ROM.

1. An image processing apparatus that executes a process based on image data in an external storage device, wherein
the external storage device is used in a state of being mounted to the image processing apparatus, and
the image processing apparatus comprises:
a displaying and accepting unit that selectably displays a post-processing delete key for deletion after the process as well as the image data in the external storage device on a touch screen;
a storing and deleting unit that, when the post-processing delete key and predetermined image data are selected, stores image data in the external storage device corresponding to the image data thus selected to an internal storage unit and deletes the image data from the external storage device; and
an image processing unit that executes the process based on the image data stored in the internal storage unit.

2. The image processing apparatus according to claim 1, wherein: the displaying and accepting unit selectably displays an only-process key for executing only the process upon display of the post-processing delete key; and
when the only-process key and predetermined image data are selected, the storing and deleting unit executes only storing of the image data in the external storage device corresponding to the image data thus selected to the internal storage unit.

3. The image processing apparatus according to claim 1, further comprising a mounting detecting unit that detects mounting of the external storage device to the image forming apparatus, wherein
when the external storage device is detected to be mounted to the image forming apparatus, the displaying and accepting unit displays the image data in the external storage device as well as the post-processing delete key on the touch screen.

4. The image processing apparatus according to claim 1, wherein, when the post-processing delete key and the predetermined image data are selected, the displaying and accepting unit pops up a setting condition input window for input of a setting condition relating to the process of the image data, and accepts the input of the setting condition.

5. The image processing apparatus according to claim 2, wherein, when the post-processing delete key and the predetermined image data are selected, the displaying and accepting unit pops up a setting condition input window for input of a setting condition relating to the process of the image data, and accepts the input of the setting condition.

6. The image processing apparatus according to claim 3, wherein, when the post-processing delete key and the predetermined image data are selected, the displaying and accepting unit pops up a setting condition input window for input of a setting condition relating to the process of the image data, and accepts the input of the setting condition.

7. An image processing method of an image processing apparatus that executes a process based on image data in an external storage device, wherein:
the external storage device is used in a state of being mounted to the image processing apparatus; and
the image processing method comprises:
a step of selectably displaying a post-processing delete key for deletion after the process as well as the image data in the external storage device on a touch screen;
a step of storing, when the post-processing delete key and predetermined image data are selected, image data in the external storage device corresponding to the image data thus selected to an internal storage unit and deleting the image data from the external storage device; and
a step of executing the process based on the image data stored in the internal storage unit.

8. A program, wherein the program makes a computer execute the image processing method according to claim 7.

9. A computer-readable storage medium, wherein the storage medium stores the program according to claim 8.
